(19) United States
(12) Patent Application Publication
(10) Pub. No.: US 2024/0147218 A1
(43) Pub. Date: May 2, 2024

(54) METHOD AND SYSTEM FOR AGNOSTIC GLOBAL CLOUD DELIVERY PLATFORM FOR CONTENT AND SERVICES

(71) Applicants: AT&T Intellectual Property I, L.P., Atlanta, GA (US); AT&T Mobility II LLC, Atlanta, GA (US)

(72) Inventors: Prashant Raghuvanshi, Parker, CO (US); Richard T. Kwapniewski, Middletown, NJ (US); Rajil Malhotra, Olathe, KS (US)

(73) Assignees: AT&T Intellectual Property I, L.P., Atlanta, GA (US); AT&T Mobility II LLC, Atlanta, GA (US)

(21) Appl. No.: 17/976,037

(22) Filed: Oct. 28, 2022

(51) Int. Cl. H04W 8/20; H04W 8/24; H04W 60/00

(52) U.S. Cl. CPC H04W 8/20; H04W 8/24; H04W 60/00

(57) ABSTRACT

Aspects of the subject disclosure may include, for example, facilitating a registration process such as by storing service information associated with a group of providers, which can include location information associated with the equipment, Data Network Name (DNN), Public Land Mobile Network (PLMN), and/or Single-Network Slice Selection Assistance Information (S-NSSAI). A service process can include wirelessly receiving a service request from a communication device, where the service request identifies a particular service and includes location information of the communication device; selecting a provider from among the group of providers according to the service request and the stored service information; and wirelessly providing provider information for the provider to the communication device that includes the corresponding DNN and the S-NSSAI of the provider, whereby the communication device can then attach to the corresponding equipment of the provider and obtain the particular service. Other embodiments are disclosed.

### FIELD OF THE DISCLOSURE

The subject disclosure relates to a method and system for agnostic global cloud delivery platform for content and services.

### BACKGROUND

A device, such as a communication device of a subscriber, an Internet-Of-Things (IOT) device, or a car which has a cellular modem, typically connects to a mobile operator and sets up a data connection with an Access Point Name (APN)/Data Network Name (DNN) configured on the device. This may allow the vehicle to connect to an operator's Public Land Mobile Network (PLMN) to obtain service in areas where there is network coverage. When the device goes out of coverage, the device may roam onto a Visiting Public Land Mobile Network (VPLMN) with an operator with which there is a roaming agreement. This mechanism of connecting to the network is very static in nature and binds a subscriber to a particular operator's supported services, which can result in an operator that may only support very few applications on their edge network with low latency and/or an operator that may only support very little content in their local region.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIGS. 2B and 2C are block diagrams illustrating example, non-limiting embodiments of data flows in a system functioning within the communication network of FIG. 1 in accordance with various aspects described herein.

FIG. 2D is a block diagram illustrating an example, non-limiting embodiment of a system functioning within the communication network of FIG. 1 in accordance with various aspects described herein.

FIG. 2E is a block diagram illustrating an example, non-limiting embodiment of data flows in a system functioning within the communication network of FIG. 1 in accordance with various aspects described herein.

FIG. 2F depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for providing a content and service delivery platform (referred to herein as platform) to which a device (e.g., a communication device, vehicle, IoT, or other device capable of providing a communication service) can access. In one or more embodiments, various network operators can register their services that they perform along with other information associated with the operators and/or services, including respective Key Performance Indicators (KPIs), to the platform. In one or more embodiments, when a device seeks a particular type of content or service, it can query the platform, such as using a default data connection over a network operator which serves the device. In one or more embodiments, based on the content or service sought by the device, the platform can send an identification of an appropriate operator network and/or other information including DNN and/or network slice information to the device. In one or more embodiments, the information (e.g., operator network identifier, DNN, slice information and so forth) can be provided via a HTTP/2 interface or other GET Request/Response interface between the device and the platform. In one or more embodiments, the network operator information in the HTTP/2 Response can specify which embedded Subscriber Identity Module (eSIM) profile to use. In one or more embodiments, the operator network information and associated user credentials can be stored on the device's eSIM. In one or more embodiments, the platform can inform the device which operator profile to use, and, if necessary or desired, trigger the device to initiate a download of a new profile such as via standard provisioning including GSMA RSP Architecture Version 3.0. In one or more embodiments, based on or following the eSIM profile selection/provisioning and DNN/slice reconfiguration, the device then connects to the provider/operator network that can provide the content or service that the user sought or is subscribed.

One or more of the exemplary embodiments enable a device or a vehicle to have the capability to move to a different operator network(s), network slice(s), and/or DNN(s) seamlessly in ways by which the device or vehicle can obtain consistent network KPI's (e.g., low latency) and which can provide an improved customer experience as compared to contemporary systems that do not provide this capability. One or more of the exemplary embodiments enable a device or a vehicle to dynamically perform content/service discovery and seamlessly move to the best, better or desired operator network that delivers that service or content on their local network, slice, and/or DNN as compared to contemporary systems that do not provide this capability. One or more of the exemplary embodiments enable network operators to provide content/service to a user/device which may not be registered as a customer on their network slice/DNN as compared to contemporary systems that do not provide this capability. Other embodiments are described in the subject disclosure.

One or more aspects of the subject disclosure include a device, comprising: a processing system including a processor; and a memory that stores executable instructions that, when executed by the processing system, facilitate performance of operations. The operations include receiving registration requests from equipment of a group of providers that are network operators, content providers, or a combination thereof. The operations include storing service information associated with each of the group of providers resulting in stored service information, wherein the stored service information includes location information associated with the equipment, DNN, PLMN, S-NSSAI or a combination thereof. The operations include wirelessly receiving a service request from a communication device, the service request identifying a particular service and including location information of the communication device. The operations include selecting a provider from among the group of providers according to the service request and the stored service information. The operations include, responsive to the service request, wirelessly providing provider information for the provider to the communication device, the provider information including the corresponding DNN and the S-NSSAI of the provider, wherein the providing of the provider information enables the communication device to attach to the corresponding equipment of the provider and to obtain the particular service.

One or more aspects of the subject disclosure include a non-transitory machine-readable medium, comprising executable instructions that, when executed by a processing system including a processor, facilitate performance of operations. The operations include wirelessly receiving a service request from a communication device, where the service request identifies a particular service. The operations include selecting a first provider and a second provider from among a group of providers according to the service request and stored service information for the group of providers that includes DNN, PLMN, S-NSSAI or a combination thereof. The operations include responsive to the service request, wirelessly providing first provider information for the first provider and second provider information for the second provider to the communication device, the first and second provider information including the corresponding DNN and the S-NSSAI of the first and second provider, wherein the providing of the first and second provider information enables the communication device to attach to either corresponding equipment of the first provider or the second provider and to obtain the particular service.

One or more aspects of the subject disclosure include a method, comprising: wirelessly receiving, by a processing system including a processor, a service request from a communication device, the service request identifying a particular service. The method includes selecting, by the processing system, a provider from among a group of providers according to the service request and stored service information for the group of providers that includes location information associated with equipment of the group of providers, DNN, PLMN, S-NSSAI, KPIs for one or more services provided by each of the group of providers, or a combination thereof. The method includes providing, by the processing system, a slicing request to the corresponding equipment of the provider. The method includes receiving, by the processing system, an S-NSSAI from the equipment of the provider according to the slicing request, wherein the S-NSSAI is different from another S-NSSAI that is in the stored service information for the provider. The method includes. responsive to the service request, wirelessly providing, by the processing system, provider information for the provider to the communication device, the provider information including the corresponding DNN and the S-NSSAI of the provider, wherein the providing of the provider information enables the communication device to attach to the corresponding equipment of the provider and to obtain the particular service.

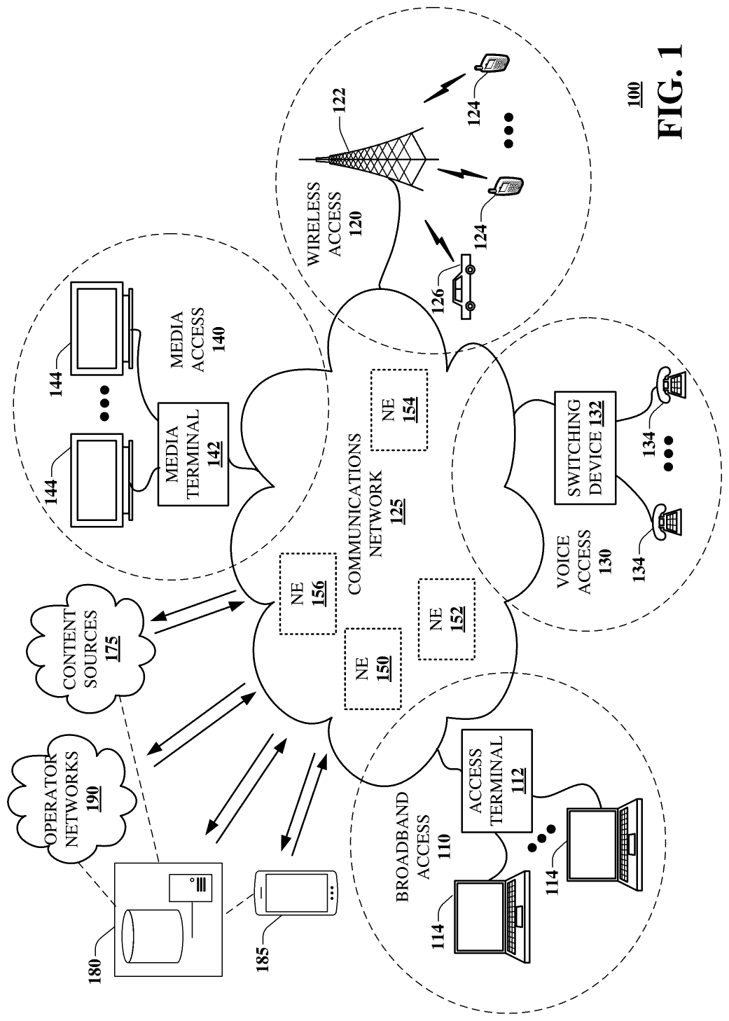

Referring now to FIG. 1, a block diagram is shown illustrating an example, non-limiting embodiment of a system 100 in accordance with various aspects described herein. System 100 can include a content and service delivery platform 180 that can communicate with one or more devices 185 (only one of which is shown). The device 185 can include, for example, a communication device, vehicle, IoT, or another device capable of providing a communication service, such as voice, video, audio, data, messaging and so forth. In one or more embodiments, various providers such as network operators 190 and/or content providers 175 (or other providers) can register their services that they perform along with other information associated with the providers and/or services, including respective KPIs, to the platform.

In one embodiment, platform 180 can receive registration requests from equipment of a group of providers 175, 190 that can be various types of providers including network operators, content providers, or a combination thereof. In this example, network operators and content providers can include any providers that provide a service (e.g., voice, video, audio, data, messaging, etc.) to a device 185, which can be various types of devices including smart phones, laptop computers, vehicles, tablets, IoTs, or other devices that can present or otherwise enable a service for a user.

In one embodiment, platform 180 can store service information associated with each of the group of providers 175, 190 resulting in stored service information, such as location information associated with the equipment of the providers, DNN, PLMN, S-NSSAI, KPIs for the service, and so forth. In one embodiment, platform 180 can wirelessly receive a service request from the device 185, such as where the service request identifies a particular service and can include other information (e.g., location information of the device, requested KPIs, and so forth).

In one embodiment, platform 180 can select a provider or multiple providers from among the group of providers according to the service request and the stored service information. Other information can also be utilized for this selection, such as performance evaluations for the providers generated by the platform or generated by other entities, incentives such as rewards and discounts, costs, agreements made with the user of the device such as utilizing only a particular set of messaging platforms when at work, and so forth. In one embodiment, this information can be based on AI/ML that is used for making predictions or otherwise determining selections or analyzing criteria.

In one embodiment, platform 180 can, responsive to the service request from device 185, wirelessly provide provider information for the provider to the device, where the provider information includes the corresponding DNN and the S-NSSAI(s) of the provider, and where the providing of the provider information enables the device to attach to the corresponding equipment of the provider and to obtain the particular service.

In one embodiment, the registration requests include the service information. In one embodiment, the stored service information includes KPIs for one or more services provided by each of the group of providers. In one embodiment, platform 180 can provide an Over-the-Air (OTA) provisioning associated with the provider to the device 185, such as an eSIM.

In one embodiment, platform 180 can receive an OTA request from the device 185, where the providing of the OTA provisioning is in response to the OTA request. In one embodiment, the OTA request can be sent from the device 185 based on the eSIM activating an operator profile.

In one embodiment, platform 180 can provide a slicing request to the equipment of the provider; and receive the S-NSSAI from the equipment of the provider according to the slicing request, where the S-NSSAI is different from any S-NSSAI that is stored in the service information for the provider.

In one embodiment, platform 180 can determine that none of the S-NSSAIs in the stored service information satisfy the service request, where the providing the slicing request to the equipment of the provider is in response to the determining that none of the S-NSSAIs in the stored service information satisfy the service request.

In one embodiment, the selecting the provider from among the group of providers is based on a machine learning model that is trained on historical performance data of the group of providers and/or other information such as historical data for a same type of service, historical data for similar devices and/or the device, and so forth.

In one embodiment, platform 180 can select one or more second providers from among the group of providers according to the service request and the stored service information; detect a triggering event associated with the particular service being provided by the provider to the communication device; and responsive to the triggering event, wirelessly provide second provider information for the one or more second providers to the communication device. In this example the second provider information can include the corresponding DNN and the S-NSSAI of the one or more second providers. Continuing with this example, the providing of the second provider information enables the communication device to selectively attach to the corresponding equipment of the one or more second providers and to continue obtaining the particular service. In one embodiment, the triggering event is one of a monitored performance parameter or a predicted future performance parameter.

In one embodiment, platform 180 can select one or more second providers from among the group of providers according to the service request and the stored service information; and responsive to the service request, wirelessly provide second provider information for the one or more second providers to the communication device. In this example, the second provider information can include the corresponding DNN and the S-NSSAI of the one or more second providers. Continuing with this example, the providing of the second provider information enables the communication device to selectively attach to the corresponding equipment of the one or more second providers to obtain the particular service. In other embodiments, the platform 180 can dictate or instruct when the device 185 is to switch between providers for a same service, such as in initial messaging that identifies multiple providers and describes triggering events for switching between providers, including specific times, specific locations, performance thresholds, or other events that the device can monitor and then switch based on detection of the event.

In other embodiments, the platform 180 can dictate or instruct when the device 185 is to switch between providers for a same service in subsequent messaging that identifies a second provider. This subsequent messaging can include a directive to switch or can include identification of the triggering event for switching to the second provider(s), such as at a specific time, at a specific location, performance thresholds, or other events that the device can monitor and then switch based on detection of the event.

In one embodiment, a process is provided that enables different connected cars to perform discovery based on the content and service they desire or need, and automatically connect to the operator which supports that service with the proper DNN and slice identifiers. For instance, if car A wants to share a movie with passengers of car B then it can do so utilizing the best available QoS through use of platform 180. In this example, passengers of both cars can view the movie together with a same live feed, so if one person in one car pauses the movie then the other vehicle's passengers also see the movie paused. Continuing with this example, this service utilizes a seamless capability where cars are connected to the platform 180 which selects the best available mobile network that can deliver the particular content. As another example, self-driving cars which are fully autonomous (without a physical driver) are provided with the capability to have direct communication with each other and to a shared network which controls the autonomous vehicle operation, such as through a remote operator that is controlling the vehicle. Platform 180 facilitates self-driving cars being provided with the capability to experience consistently low latency (e.g., low 10 ms range) through selection of the appropriate providers which enables them to perform critical maneuvers, detect other objects, and communicate between other cars to reduce the chance of a collision. The platform 180 can allow the cars to have a capability to be always connected to a low latency network which meets their KPIs. The platform 180 allows the cars to seamlessly switch mobile network HPLMN (Home PLMN) operators in order to obtain the consistent low latency.

As another example, system 100 can facilitate in whole or in part a registration process such as by receiving registration requests from equipment of a group of providers that are network operators, content providers, or a combination thereof, and storing service information associated with each of the group of providers resulting in stored service information, which can include location information associated with the equipment, DNN, PLMN, S-NSSAI or a combination thereof. A service process can be implemented that facilitates: wirelessly receiving a service request from a communication device, where the service request identifies a particular service and includes location information of the communication device; selecting a provider from among the group of providers according to the service request and the stored service information; and responsive to the service request, wirelessly providing provider information for the provider to the communication device, the provider information including the corresponding DNN and the S-NSSAI of the provider, wherein the providing of the provider information enables the communication device to attach to the corresponding equipment of the provider and to obtain the particular service.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.1 lac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

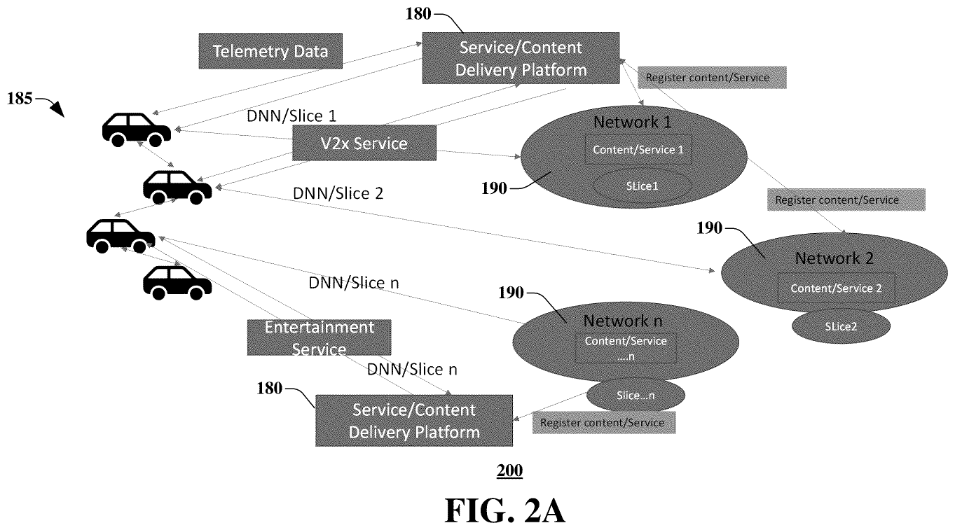

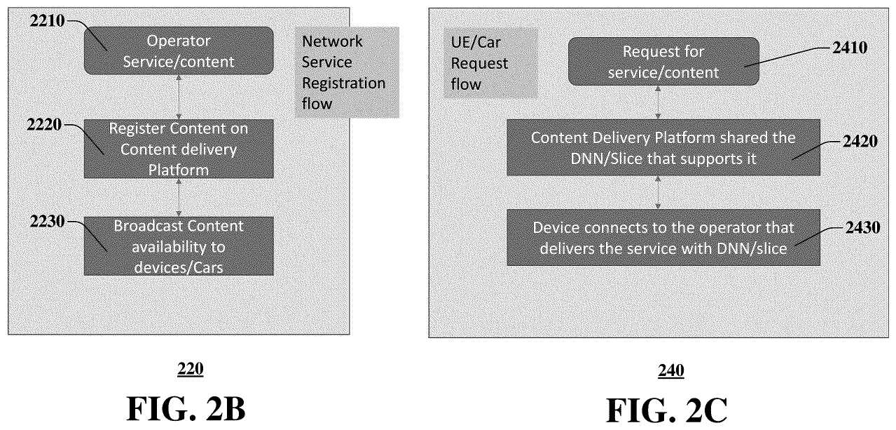

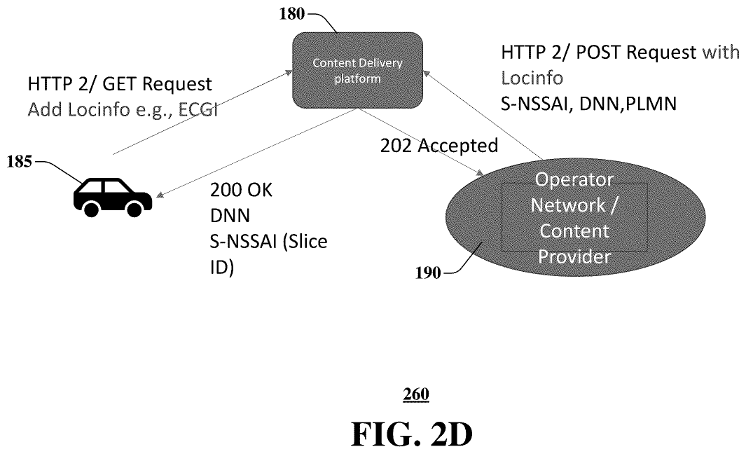

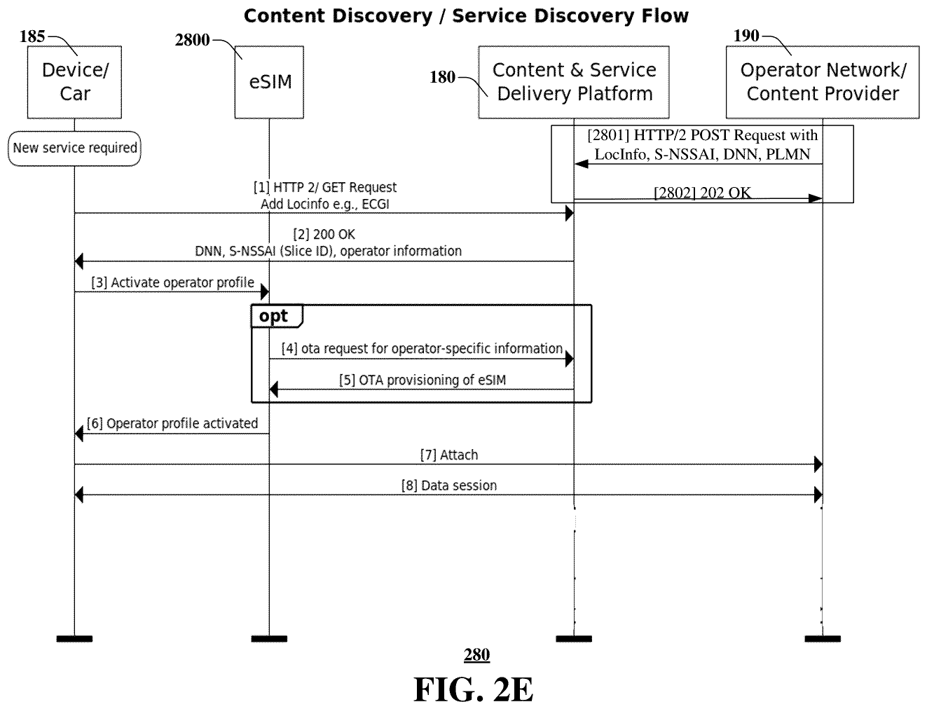

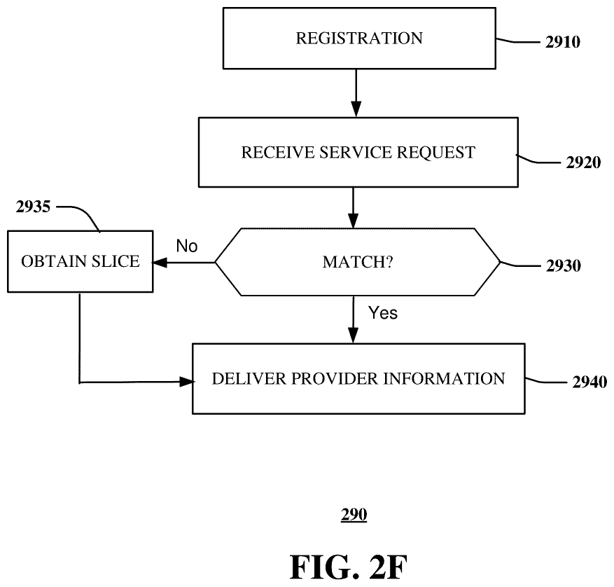

FIG. 2A is a block diagram illustrating an example, non-limiting embodiment of a system 200 functioning within the communication network of FIG. 1 in accordance with various aspects described herein. System 200 illustrates wireless communications between devices 185 (which are shown as vehicles but could be other wireless devices) and content and service delivery platforms 180. System 200 further illustrates providers 190 communicating with the platforms 180 including during a registration process, and providing requested services to the devices 185 when the platforms select the particular provider(s).

As an example, a platform 180 can wirelessly receive a service request from a device 185, where the service request identifies a particular service such as a V2X service or an entertainment service. Providers can be selected, including a single provider or multiple providers for each of the service requests, from among a group of providers according to the service request(s) and stored service information for the group of providers, which can include DNN, PLMN, S-NSSAI, location information, KPIs or a combination thereof.

The platforms 180, responsive to the service requests, can wirelessly provide provider information that enables attachment by the device 185 to the providers 190. In one embodiment, the platform 180 can provide first provider information for a first provider and second provider information for a second provider to the device 185, where the first and second provider information includes the corresponding DNN and the S-NSSAI of the first and second provider, where the providing of the first and second provider information enables the device to attach to either corresponding equipment of the first provider or the second provider and to obtain the particular service. Other information can be communicated between the devices 185 and the platforms 180, such as telemetry data.

In one embodiment, the platform 180 can wirelessly provide switching information to the device 185 to indicate a triggering event for the device for switching between the corresponding equipment of the first and second provider to obtain the particular service. In one embodiment, the triggering event is a time period, a performance parameter threshold, a coverage area or a combination thereof.

In one embodiment, the platform 180 can provide a slicing request to the equipment of the first provider; and can receive the S-NSSAI from the equipment of the first provider according to the slicing request, where the S-NSSAI is different from another S-NSSAI that is in the stored service information for the first provider.

In one embodiment, the platform 180 can determine that none of the S-NSSAIs in the stored service information satisfy the service request, where the providing the slicing request to the equipment of the provider is in response to the determining that none of the S-NSSAIs in the stored service information satisfy the service request.

In one embodiment, the platform 180 can select the first and second providers from among the group of providers based on a machine learning model that is trained on historical performance data of the group of providers.

FIG. 2B depicts an illustrative embodiment of a method 230 in accordance with various aspects described herein. At 2210, providers can collect or generate service information that can be shared with a platform for delivering services and at 2220 the providers can register with the platform. In one embodiment at 2230, an availability of services and/or content can be broadcast to devices (e.g., cars or other mobile devices). For example, the broadcast can be from the platform, from the providers, and/or from other entities.

FIG. 2C depicts an illustrative embodiment of a method 240 in accordance with various aspects described herein. At 2410, devices can transmit service requests to platforms, such as via a default data connection or other wireless channel. At 2420, the platform can select a provider(s) and share particular information with the device that facilitates attachment to the provider such as DNN, slicing data, and so forth. At 2430, the device can connect with equipment of the provider utilizing the information that it received from the platform in order to obtain the particular communication service.

FIG. 2D is a block diagram illustrating an example, non-limiting embodiment of a system 260 functioning within the communication network of FIG. 1 in accordance with various aspects described herein. System 260 illustrates wireless communications between a device 185 (which is shown as a vehicle but could be other wireless devices including smart phones, laptop computers, gaming consoles, tablets, IoTs, and so forth) and content and service delivery platform 180. System 260 further illustrates equipment of provider 190 communicating with the platform 180. In this example, HTTP/2 messaging can be utilized such as a registration process whereby the provider 190 provides location information, S-NSSAI, DNN, and PLMN by which the provider would be providing a particular service(s). Continuing with this example, the platform 180 and the device 185 can also communicate via HTTP/2 messaging such as a service request that can include location information (e.g., ECGI) for the device and a response from the platform that can include provider information (after selecting a particular provider according to the service request and/or other criteria) such as DNN and slice ID for the provider.

FIG. 2E is a block diagram illustrating an example, non-limiting embodiment of a data flow 280 functioning within the communication network of FIG. 1 in accordance with various aspects described herein. Data flow 280 illustrates wireless communications between a device 185 (having an eSIM 2800) and content and service delivery platform 180. Data flow 280 further illustrates equipment of provider 190 communicating with the platform 180 and then also communicating with the device 185 to provide the service. In this example, HTTP/2 messaging can be utilized, although other communication protocols could also be utilized. At step 2801 a registration message is sent from the provider 190 to the platform 180 which can include various provider information such as location information, S-NSSAI, DNN, PLMN by which the provider would be providing a particular service(s). At 2802, the platform can acknowledge the registration.

Continuing with this example, at step 1 the platform 180 can receive a service request from the device 185 which can include various information such as identification of a type of service, location information, KPIs for the service, and so forth. At step 2, after the platform has selected one or more providers that are appropriate or desired to provide the service, the platform 180 can provide to the device 185 provider information such as DNN, S-NSAI, operator information, and so forth. At step 3, upon receiving the provider information, the device 185 can cause the eSIM 2800 to activate an operator profile.

In one embodiment, at step 4, the eSIM and/or the device 185 can perform an OTA request to the platform 180 for operator specific information. In this example, at step 5, the platform can perform or cause to be performed OTA provisioning of the eSIM, where the provisioning provides whatever additional information is needed to enable an attachment by the device 185 to the equipment of the provider 190.

At step 6, the operator profile can be activated and at step 7 the device can attach to the platform 180. At step 8, a service can be provided to the device 185 by the platform 180, such as a data session or other communication session. Other steps not shown can also be utilized to facilitate selection of a provider(s) and attachment of the device to the provider for a particular service.

FIG. 2F depicts an illustrative embodiment of a method 290 in accordance with various aspects described herein. At 2910, a registration process can be performed. This process can be at various intervals, including when new providers desire to register and/or when existing providers are changing their services, content, operations, network slicing, and so forth. As an example, the platform can receive registration requests from equipment of a group of providers that are network operators (e.g., entities that provide communication services), content providers, or a combination thereof. As described herein, the providers can be of various types including telecommunication service providers that own their own infrastructure, service providers that do not own their own infrastructure, cloud service operators, content providers, social platforms, gaming platforms, business platforms, educational platforms, and so forth. In one embodiment, service information can be stored by the platform that is associated with each of the registering providers. For example, the stored service information can include location information associated with the equipment that would provide the particular service, DNN, PLMN, and/or S-NSSAI(s). Other information can also be provided that facilitates selection of a provider for a requested service, such as KPIs that the provider guarantees or otherwise will provide for the service. In one embodiment, the registration requests include the service information. In other embodiments, the service information can be updated by each of the providers. In other embodiments, the updated service information can be content that has become available. The frequency of updates can vary including being periodic, scheduled or based on triggering events such as release of new movies.

At 2920, the platform can receive, such as via a wireless connection which can include a default data connection, a service request from a communication device, where the service request identifies a particular service sought. As described herein, the service can be of various types including voice, video, audio, data, messaging, gaming, social platform, business platform, educational platform and so forth. In one embodiment, the service request can include QoS requirements or parameters. In one embodiment, the service request can include location information for the device.

At 2930, a determination can be made by the platform as to whether a match exists between the service request and a provider (or particular capabilities of a provider). In one embodiment, at 2935, if additional information is needed to identify a particular match or to provide to the device to connect with a particular provider, then the platform can send a request to the particular provider (or a group of providers that are under consideration for selection) for the particular information. For example, the platform can request a particular S-NSSAI(s) based on various criteria such as the type of service being requested, KPIs that the device is requesting, or other criteria to be satisfied (e.g., when the pre-configured slices or S-NSSAIs stored in the service information do not satisfy the criteria). In this example, the provider(s) can receive the request and can generate, select or configure a particular network slice that satisfies the request, and can then send to the platform the relevant information, such as the S-NSSAI(s) corresponding to the slice.

At 2940, the platform can select a provider(s) from among a group of providers according to the service request and the stored service information for the group of providers (from the registration process). As an example, the platform can compare: location information associated with equipment of the group of providers to the location of the device, KPIs sought to KPIs deliverable by the providers, S-NSSAI(s) available, or other information that can be used for determining a provider(s) can provide a best or better service to the device.

In one embodiment, responsive to the service request, the platform can wirelessly provide provider information for the provider to the communication device. In one embodiment, the provider information can include the corresponding DNN and the S-NSSAI of the provider. In one embodiment, the providing of the provider information enables the communication device to attach to the corresponding equipment of the provider and to obtain the particular service.

In one embodiment, the platform can determine that none of the S-NSSAIs in the stored service information satisfy the service request, where the providing the slicing request to equipment of a provider(s) (which may satisfy or otherwise match other criteria of the service request) is in response to the determining that none of the S-NSSAIs in the stored service information satisfy the service request.

While for purposes of simplicity of explanation, the respective processes are shown and described as a series of blocks in FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In one embodiment, the system and methodology described herein can allow a service provider to monetize service/content delivery to subscribers who are not customers of the service provider. In one embodiment, a platform can be provided that is operator agnostic, so customers can access services seamlessly and can expect a more predictive QoS behavior without regard to the network operator coverage they are being served under.

In one embodiment, the platform can use predictions to determine a best or better provider or otherwise select a provider such as applying AI/ML to predict speed/direction and future location(s) for the device including time periods when service will be delivered at that predicted location. In one embodiment, the platform can apply AI/ML to predict user interaction(s) with a requested service (e.g., how long a user will be watching a movie based on predictions of number of pauses, rewinds, interruptions, etc.). In one embodiment, the platform can apply AI/ML to predict future network parameters that can then be utilized as a criteria for selecting particular providers, such as selecting provider X because it handles network congestion better than provider Y where future network congestion is predicted. In one embodiment, the platform can apply AI/ML to predict how long a service is expected to last, such as predicting that a particular user typically uses VR service for one hour when fewer players are in the VR world and further predicting that there will be below a threshold number of players in the VR world. In one embodiment, the platform can (with or without applying AI/ML) supplement self-reporting by operators with an evaluation of the providers and their services, such as based on observed performance/behavior. As an example, this evaluation can be utilized in selecting a provider.

In one or more embodiments, a system can provide for intelligent selection of providers, such as network operators and content providers. In one embodiment, the system and methodology is not limited to utilizing a particular operator due to an intra-operator agreement. In one embodiment, the platform can be made aware of the capabilities of each of the providers. In one embodiment, the platform can select what it determines is the optimal or a better operator and/or optimal or a better network slice(s).

In one embodiment, the interface or communication can occur between end users, end user devices and/or the platform(s) to obtain the information necessary for selecting a provider or combination of provider for a particular service(s).

In one embodiment, the platform can select from among preconfigured network slices and/or can request that the provider(s) create a network slice(s) that meets the KPI(s) or other requirements for the requested service. In one embodiment, the platform can request particular content from content providers and/or request particular formats of the particular content from the content providers where the platform does not find a match for the content (and/or format) in the stored service information. In one embodiment, the service information of the providers that are stored by the platform can include identifying content and/or formats of content that are available for delivery by the content provider. In one embodiment, the platform can interface with various devices to provide a real time configuration of network slicing from the network.

In one embodiment, service requests can be based on broadcasting of service availability, such as by the platform and/or by the providers. In another embodiment, the service requests are sent without receiving a broadcast of available services, such as where the device is aware of available services, such as in a particular area. In one embodiment, the registration process at the platform (including frequency and information to be provided) can be configurable or adjustable by the platform, including enabling service and content providers to update service information when a certain amount of content changes, when DRM/rights change, when capabilities are added or removed, and so forth. In one embodiment, the provider information sent from the platform to the device can include all of the information necessary so that the device can obtain service through that provider.

In one embodiment, the provider information includes location information so that the platform can compare it to the location of the device to facilitate an efficient delivery of the service, such as streaming video from a local server. In one embodiment, the location information provided by a provider can include coverage areas and/or regions that it serves.

In one embodiment, the platform can send a request to one or more registered providers for more information associated with the capabilities of the provider to facilitate selecting a provider that matches the service request. In one embodiment, the providing of the provider information enables authentication by the device to the equipment of the provider.

In one embodiment, the eSIM of the device may have already authenticated with that platform and/or with the provider, which can facilitate attachment to the provider and can reduce that amount of information that is processed or communicated to achieve the attachment. In one embodiment, the eSIM can obtain and utilize security keys to facilitate attachment to the provider, as well as other information such as PLMN information, a unique identifier, an IMSI and so forth.

In one embodiment, the device 185 can utilizing removable SIM cards to obtain the service from the provider according to various functionality described herein such as receiving provider information from the platform.

In one embodiment, the platform can utilize historical provider selections and/or historical slice selections to facilitate selecting a particular provider and/or a particular slice (e.g., where multiple network slices are available).

In one embodiment, the platform can provide options to be selected by the device and/or the user of the device, such as sending an identification of multiple providers that can satisfy the service request. In one embodiment, the selection of options among the providers by the device and/or user can be based on KPIs, price points, promotions and so forth, which in one embodiment can be presented to the user.

In one embodiment, the platform can provide load balancing between equipment of the providers, such as where multiple providers match the KPIs or other criteria of the service request. In one embodiment, the platform can monitor the performance of the service (e.g., based on KPIs) and can provide other provider information for another provider when the KPIs are not being satisfied by the first provider. In one embodiment, the providing of other provider information for another provider can be performed by the platform based on other factors, such as determining or predicting network congestion.

In one embodiment, the platform can send provider information for multiple providers along with a performance parameter threshold(s) and an instruction that the device should switch to the second (or more) providers when the threshold(s) is not being satisfied. In one embodiment, the platform can send prediction information to the device to facilitate the device switching to a provider, such as a prediction that a first provider performance will no longer satisfy a threshold in one hour or when the device (e.g., a car) reaches a particular geographic location.

In one embodiment, the platform can operate as a discovery point for the operator, and a management point for switching between operators.

In one embodiment, the platform can include a content delivery cache platform so that particular content can be cached locally rather than provider equipment needing to deliver the content. As an example, particular movies, which are determined to be popular and for which the entity operating the platform and the entity that is authorized to distribute the content have reached an agreement to allow local delivery, can be locally cached at equipment of the platform in order to make delivery more efficient to the requesting device.

In one embodiment, the platform can be executed at various devices in a network including the network core, edge servers, virtual machines, and so forth. In one embodiment, the platform can ne operated by various entities including telecommunication service providers, content providers, third party entities, and so forth.

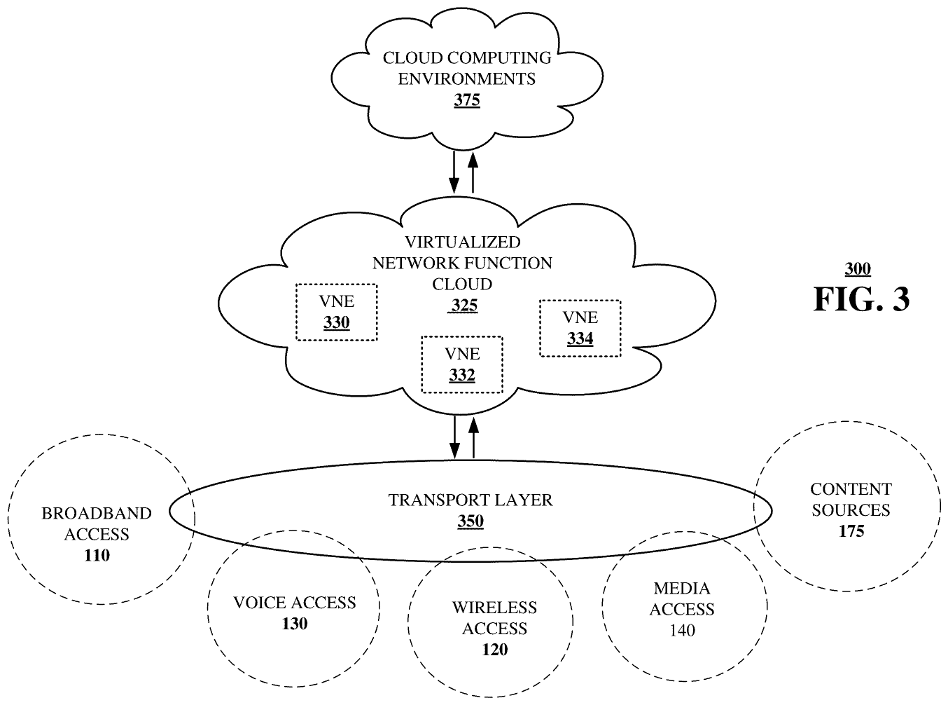

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A-2F and 3. For example, virtualized communication network 300 can facilitate in whole or in part a registration process such as by receiving registration requests from equipment of a group of providers that are network operators, content providers, or a combination thereof; and storing service information associated with each of the group of providers resulting in stored service information, which can include location information associated with the equipment, DNN, PLMN, S-NSSAI or a combination thereof. A service process can be implemented that facilitates: wirelessly receiving a service request from a communication device, where the service request identifies a particular service and includes location information of the communication device; selecting a provider from among the group of providers according to the service request and the stored service information; and responsive to the service request, wirelessly providing provider information for the provider to the communication device, the provider information including the corresponding DNN and the S-NSSAI of the provider, wherein the providing of the provider information enables the communication device to attach to the corresponding equipment of the provider and to obtain the particular service.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

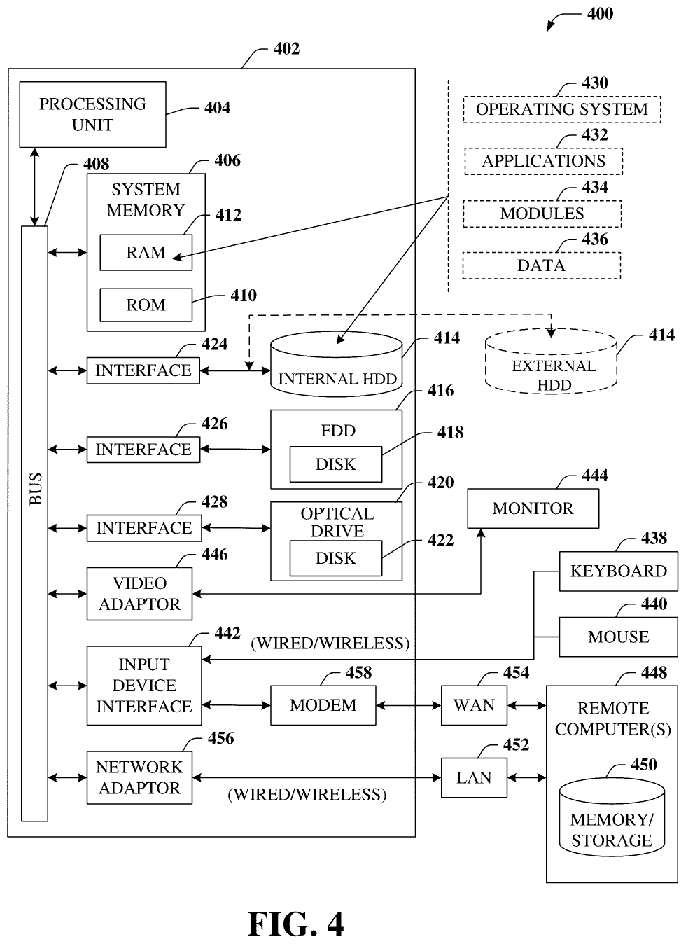

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software.

For example, computing environment 400 can facilitate in whole or in part a registration process such as by receiving registration requests from equipment of a group of providers that are network operators, content providers, or a combination thereof, and storing service information associated with each of the group of providers resulting in stored service information, which can include location information associated with the equipment, DNN, PLMN, S-NSSAI or a combination thereof. A service process can be implemented that facilitates: wirelessly receiving a service request from a communication device, where the service request identifies a particular service and includes location information of the communication device; selecting a provider from among the group of providers according to the service request and the stored service information; and responsive to the service request, wirelessly providing provider information for the provider to the communication device, the provider information including the corresponding DNN and the S-NSSAI of the provider, wherein the providing of the provider information enables the communication device to attach to the corresponding equipment of the provider and to obtain the particular service.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

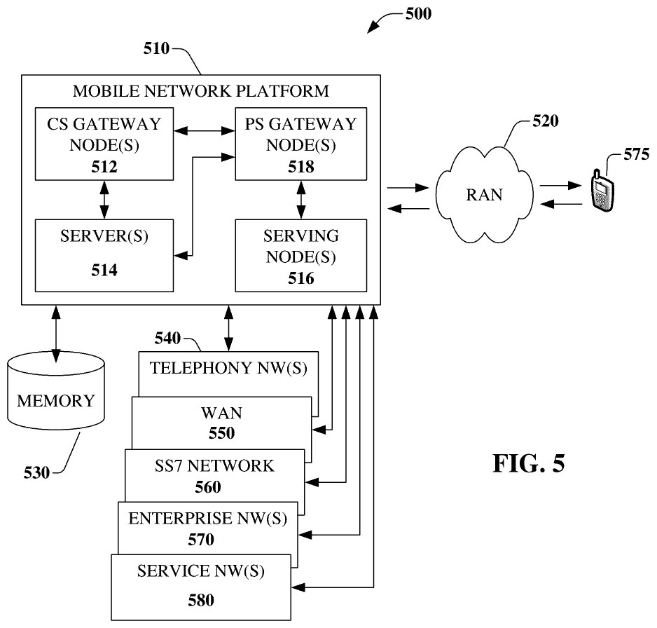

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part a registration process such as by receiving registration requests from equipment of a group of providers that are network operators, content providers, or a combination thereof; and storing service information associated with each of the group of providers resulting in stored service information, which can include location information associated with the equipment, DNN, PLMN, S-NSSAI or a combination thereof. A service process can be implemented that facilitates: wirelessly receiving a service request from a communication device, where the service request identifies a particular service and includes location information of the communication device; selecting a provider from among the group of providers according to the service request and the stored service information; and responsive to the service request, wirelessly providing provider information for the provider to the communication device, the provider information including the corresponding DNN and the S-NSSAI of the provider, wherein the providing of the provider information enables the communication device to attach to the corresponding equipment of the provider and to obtain the particular service.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

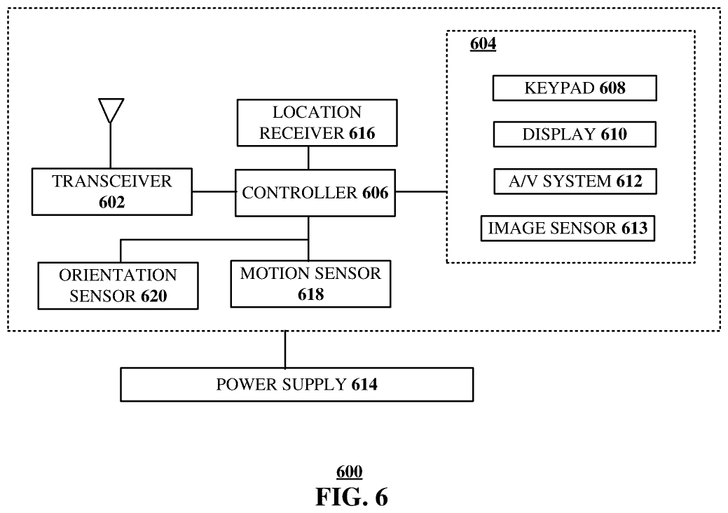

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part a registration process such as by receiving registration requests from equipment of a group of providers that are network operators, content providers, or a combination thereof, and storing service information associated with each of the group of providers resulting in stored service information, which can include location information associated with the equipment, DNN, PLMN, S-NSSAI or a combination thereof. A service process can be implemented that facilitates: wirelessly receiving a service request from a communication device, where the service request identifies a particular service and includes location information of the communication device; selecting a provider from among the group of providers according to the service request and the stored service information; and responsive to the service request, wirelessly providing provider information for the provider to the communication device, the provider information including the corresponding DNN and the S-NSSAI of the provider, wherein the providing of the provider information enables the communication device to attach to the corresponding equipment of the provider and to obtain the particular service.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving registration requests from equipment of a group of providers that are network operators, content providers, or a combination thereof,
storing service information associated with each of the group of providers resulting in stored service information, wherein the stored service information includes location information associated with the equipment, Data Network Name (DNN), Public Land Mobile Network (PLMN), Single-Network Slice Selection Assistance Information (S-NSSAI) or a combination thereof;
wirelessly receiving a service request from a communication device, the service request identifying a particular service and including location information of the communication device;
selecting a provider from among the group of providers according to the service request and the stored service information; and
responsive to the service request, wirelessly providing provider information for the provider to the communication device, the provider information including the corresponding DNN and the S-NSSAI of the provider, wherein the providing of the provider information enables the communication device to attach to the corresponding equipment of the provider and to obtain the particular service.

2. The device of claim 1, wherein the registration requests include the service information.

3. The device of claim 1, wherein the stored service information includes KPIs for one or more services provided by each of the group of providers.

4. The device of claim 1, wherein the operations further comprise providing an Over-the-Air (OTA) provisioning associated with the provider to an eSIM of the communication device.

5. The device of claim 4, wherein the operations further comprise receiving an OTA request from the communication device, wherein the providing of the OTA provisioning is in response to the OTA request, and wherein the OTA request is based on the eSIM activating an operator profile.

6. The device of claim 1, wherein the operations further comprise:
providing a slicing request to the equipment of the provider; and
receiving the S-NSSAI from the equipment of the provider according to the slicing request, wherein the S-NSSAI is different from another S-NSSAI that is stored in the service information for the provider.

7. The device of claim 6, wherein the operations further comprise:
determining that none of the S-NSSAIs in the stored service information satisfy the service request, wherein the providing the slicing request to the equipment of the provider is in response to the determining that none of the S-NSSAIs in the stored service information satisfy the service request.

8. The device of claim 1, wherein the selecting the provider from among the group of providers is based on a machine learning model that is trained on historical performance data of the group of providers.

9. The device of claim 1, wherein the operations further comprise:
selecting a second provider from among the group of providers according to the service request and the stored service information;
detecting a triggering event associated with the particular service being provided by the provider to the communication device; and
responsive to the triggering event, wirelessly providing second provider information for the second provider to the communication device, the second provider information including the corresponding DNN and the S-NSSAI of the second provider, wherein the providing of the second provider information enables the communication device to attach to the corresponding equipment of the second provider and to continue obtain the particular service.

10. The device of claim 9, wherein the triggering event is one of a monitored performance parameter or a predicted future performance parameter.

11. The device of claim 1, wherein the operations further comprise:
selecting a second provider from among the group of providers according to the service request and the stored service information; and
responsive to the service request, wirelessly providing second provider information for the second provider to the communication device, the second provider information including the corresponding DNN and the S-NSSAI of the second provider, wherein the providing of the second provider information enables the communication device to selectively attach to the corresponding equipment of the second provider to obtain the particular service.

12. A non-transitory machine-readable medium, comprising executable instructions that, when executed by a processing system including a processor, facilitate performance of operations, the operations comprising:
wirelessly receiving a service request from a communication device, the service request identifying a particular service;
selecting a first provider and a second provider from among a group of providers according to the service request and stored service information for the group of providers that includes Data Network Name (DNN), Public Land Mobile Network (PLMN), Single-Network Slice Selection Assistance Information (S-NSSAI) or a combination thereof; and
responsive to the service request, wirelessly providing first provider information for the first provider and second provider information for the second provider to the communication device, the first and second provider information including the corresponding DNN and the S-NSSAI of the first and second provider, wherein the providing of the first and second provider information enables the communication device to attach to either corresponding equipment of the first provider or the second provider and to obtain the particular service.

13. The non-transitory machine-readable medium of claim 12, wherein the operations further comprise receiving registration requests from equipment of a group of providers that are network operators, content providers, or a combination thereof, wherein the service request includes location information of the communication device, wherein the stored service information includes location information associated with the equipment of the providers.

14. The non-transitory machine-readable medium of claim 12, wherein the operations further comprise wirelessly providing switching information to the communication device to indicate a triggering event for the communication device for switching between the corresponding equipment of the first and second provider to obtain the particular service.

15. The non-transitory machine-readable medium of claim 14, wherein the triggering event is a time period, a performance parameter threshold, a coverage area or a combination thereof.

16. The non-transitory machine-readable medium of claim 12, wherein the operations further comprise:
providing a slicing request to the equipment of the first provider; and
receiving the S-NSSAI from the equipment of the first provider according to the slicing request, wherein the S-NSSAI is different from another S-NSSAI that is in the stored service information for the first provider.

17. The non-transitory machine-readable medium of claim 16, wherein the operations further comprise:
determining that none of the S-NSSAIs in the stored service information satisfy the service request, wherein the providing the slicing request to the equipment of the provider is in response to the determining that none of the S-NSSAIs in the stored service information satisfy the service request.

18. The non-transitory machine-readable medium of claim 12, wherein the selecting the first and second providers from among the group of providers is based on a machine learning model that is trained on historical performance data of the group of providers.

19. A method, comprising:
wirelessly receiving, by a processing system including a processor, a service request from a communication device, the service request identifying a particular service;
selecting, by the processing system, a provider from among a group of providers according to the service request and stored service information for the group of providers that includes location information associated with equipment of the group of providers, Data Network Name (DNN), Public Land Mobile Network (PLMN), Single-Network Slice Selection Assistance Information (S-NSSAI), KPIs for one or more services provided by each of the group of providers, or a combination thereof,
providing, by the processing system, a slicing request to the corresponding equipment of the provider;
receiving, by the processing system, an S-NSSAI from the equipment of the provider according to the slicing request, wherein the S-NSSAI is different from another S-NSSAI that is in the stored service information for the provider; and
responsive to the service request, wirelessly providing, by the processing system, provider information for the provider to the communication device, the provider information including the corresponding DNN and the S-NSSAI of the provider, wherein the providing of the provider information enables the communication device to attach to the corresponding equipment of the provider and to obtain the particular service.

20. The method of claim 19, comprising:
determining, by the processing system, that none of the S-NSSAIs in the stored service information satisfy the service request, wherein the providing the slicing request to the equipment of the provider is in response to the determining that none of the S-NSSAIs in the stored service information satisfy the service request.
